(19) United States
(12) Patent Application Publication
(10) Pub. No.: US 2011/0032648 A1
(43) Pub. Date: Feb. 10, 2011

(54) ESD PROTECTION

(75) Inventors: Frederic Darthenay, Saint Aubin Sur Mer (FR); Taede Smedes, Beuningen (NL); Sebastien Jacquet, Vendes (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/936,637

(22) PCT Filed: Mar. 3, 2009
(86) PCT No.: PCT/IB2009/051342

§ 371 Date: Oct. 6, 2010

(30) Foreign Application Priority Data
Apr. 9, 2008 (EP) 08103462.1

(51) Int. Cl. H02H 9/00

(52) U.S. Cl. 361/56

(57) ABSTRACT

An electrostatic discharge protection structure (200) for an integrated circuit, the electrostatic discharge protection structure (200) comprising: a first silicon controlled rectifier structure (211) having a first triggering voltage, the first rectifier structure (211) being directly connected to an input (250) of the electrostatic discharge protection structure (200); a second silicon controlled rectifier structure (222) having a second triggering voltage lower than the first triggering voltage, the second rectifier structure (222) being connected to the input (250) via a resistor (221); and a secondary over-voltage protection unit (231) connected to the input (250) via the resistor (221).

The present invention relates to electrostatic discharge (ESD) protection, in particular for protection of integrated circuits (ICs).

ESD constraints are tending to become more severe, in particular regarding connections between electronic equipment. A standard for system level protection against electrostatic discharge relating to consumer electronic equipments is defined by IEC 61000-4-2.

Integrated circuits intended for connection to external devices must be capable of providing a high level of ESD protection, for example as defined in IEC TS62228 relating to electromagnetic compatibility (EMC) for controller area network (CAN) drivers. These protection levels are much more stringent than required by known human body model (HBM) or machine model (MM) levels. If a particular IC is unable to offer such a high degree of ESD protection, extra protection measures may need to be employed. Such extra protection may, for example, involve additional components for each external connection, which can increase the complexity of the equipment and add to the overall cost.

A problem with designing such protection is that of being able to offer high ESD protection levels and a low input capacitance. Typical standard ESD strategies are not able to offer both at the same time.

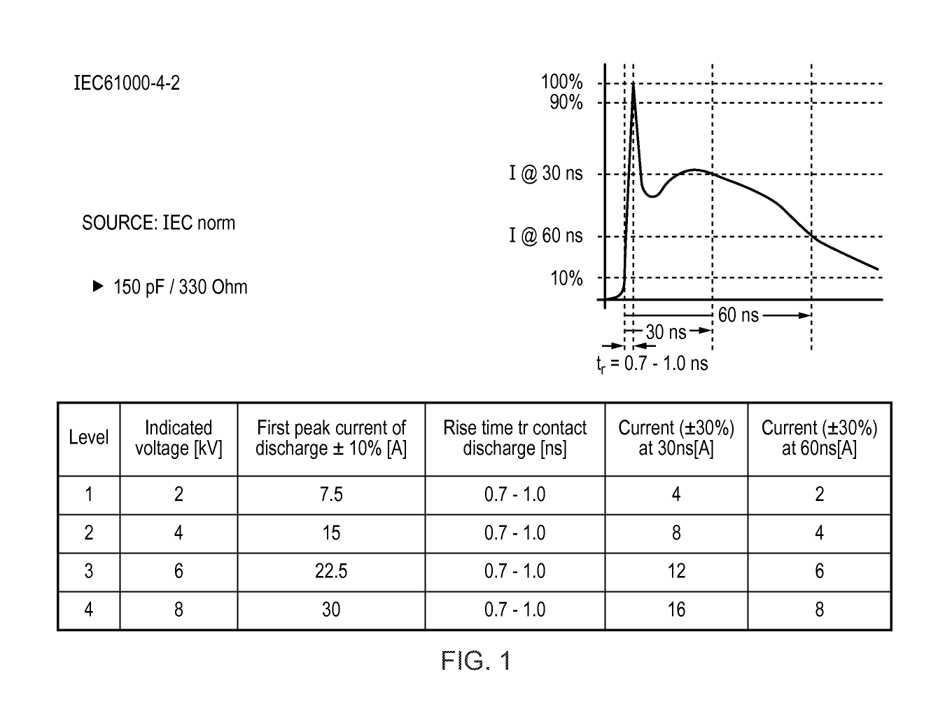

The standard that has to be met for system level protection against an electrical pulse, designed to simulate an electrostatic discharge, is very severe, and involves as much as 32 A over a few nanoseconds, followed by 15 A for about 100 ns. An illustration of a typical requirement is shown in FIG. 1, taken from the relevant IEC standard. Such a high current spike is around four times the magnitude given by the human body model.

In modern IC technology, LVTSCR (Low-Voltage Triggered Silicon Controlled Rectifier) structures are often used. A LVTSCR structure offers a low trigger and holding voltage to protect the thin gate oxide layer of an input stage, but at the penalty of a higher input capacitance due to more highly doped junctions.

Other structures such as LSCR (Lateral Silicon Controlled Rectifier) structures tend to be more robust but less efficient. For the same current capability, a LSCR structure offers a lower capacitance, but does not properly protect the input stage as the trigger voltage is too high.

It is an therefore an object of the present invention to address the above problems by providing a new strategy to provide ESD protection for IC inputs that are connectable to external devices.

According to the invention there is provided an electrostatic discharge protection circuit for an integrated circuit, the electrostatic discharge protection circuit comprising:

a first silicon controlled rectifier structure having a first triggering voltage, the first rectifier structure being directly connected to an input of the circuit;

a second silicon controlled rectifier structure having a second triggering voltage lower than the first triggering voltage, the second rectifier being connected to the input via a resistor; and

a secondary over-voltage protection unit connected to the input via the resistor.

The present invention allows for system level protection that is compatible with a low input capacitance.

The new ESD protection enabled by the invention can be embedded inside the pad of an IC chip, thus allowing system level protection (as described in IEC-TS 62228) and also a high input signal bandwidth.

Embodiments of the present invention will now be described by way of example and with reference to the accompanying drawings in which:

FIG. 1 shows an exemplary set of ESD requirements to be met by a device; and

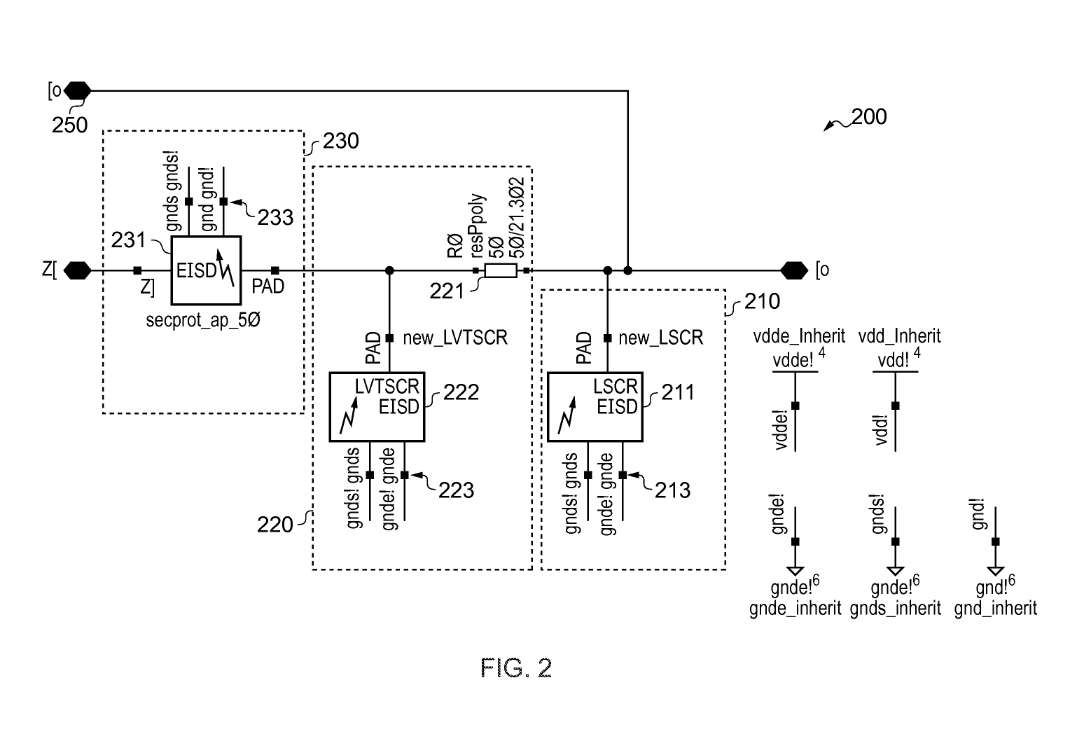

FIG. 2 shows an exemplary circuit diagram of an embodiment of the invention.

Typical pad-based protection systems comprise a first stage which drains the HBM (or MM) current pulse, and a secondary over-voltage protection unit that protects input gate oxide from overstress. On mature technologies the first stage is typically composed of a LSCR or SCR structure whose holding and triggering voltages are quite high. A typical trigger value for a LSCR is 30V on a low ohmic substrate, making LSCR structures inefficient on modern technologies. LVTSCR structures, however, exhibit lower holding and triggering voltages, typical values being 8V and 4V for a LVTSCR on a similar low ohmic substrate, but at the penalty of a higher capacitance due to being built around highly doped junctions that offer the low breakdown voltage. The n+ bridge can be shown to provide the largest contribution to the capacitance. For comparison, on a similar low ohmic substrate at 0V bias and 100 MHz, an exemplary LVTSCR provides 2.45 fF/μm compared to a LSCR of 1.12 fF/μm.

The invention combines the different advantages of LSCR and LVTSCR structures with a secondary protection unit, resulting in a three-stage structure as shown by example in FIG. 2 (each stage being indicated within dashed borders 210, 220, 230). Each of the structures 211, 222, 231 is connected between an input of the circuit 250 and one or more ground connections 213, 223, 233, to enable current to be drained to ground when the ESD circuit is activated.

A first stage 210 comprises a LSCR structure 211 directly connected to an input 250 of the circuit 200, the LSCR structure 211 having a triggering voltage that may be quite high (as described above), but which offers a low input capacitance for a high current capability compared to a LVTSCR. This first stage 210 effectively handles the initial 32 A current pulse. The second stage 220 comprises a resistor 221 and a LVTSCR 222 whose holding and triggering voltages are compatible with the technology being used. The resistor 222 limits current flowing through to the LVTSCR 220. The third stage 230 comprises a standard secondary protection unit 231, which protects against over-voltage.

The standard secondary protection unit 231 typically consists of a resistor and one or more (smaller) ESD devices, such as diodes or grounded gate NMOS transistors, as described in previous works relating to ESD protection such as by A Z H Wang in “On-chip ESD Protection for Integrated Circuits: An IC Design Perspective”, pp 74-75, Kluwer, 2002.

During a first phase of a ESD stress test, the voltage across the LVTSCR 222 and the LSCR 211 rises until the LVTSCR 222 triggers. Current then flows through the resistor 221 and the LVTSCR 222 to ground. The voltage across the resistor 221 and the LVTSCR 222 increases until it reaches the triggering voltage of the LSCR 211, which then triggers on, driving the main part of the current spike and clamping the applied voltage.

The resistor 221 and the LVTSCR 222 are configured to drain a small part of the 32 A current spike, for example below 1 A. A suitable value for the resistor can be calculated by the following equation:

$$R = \frac{{V}_{trigLSCR} - {V}_{holdLVTSCR}}{{I}_{maxLVTSCR}}$$

i.e. R being the difference between the trigger voltage of the LSCR and the hold voltage of the LVTSCR divided by the maximum current through the LVTSCR.

The resistor 221 plays two different roles, in both limiting the current flowing through the LVTSCR 222 as well as helping the voltage across the LSCR 211 to more quickly reach a triggering level by holding up the input voltage.

During a second phase, both the LSCR 211 and the LVTSCR 222 drain the current. As the current drained by the LVTSCR is very low, its size can be reduced compared to a conventional 2 kV HBM LVTSCR, which consequently reduces its parasitic capacitance. The value of the resistor 221 is typically of the order of 100 Ohms, which is acceptable for any input stage of a MOS gate. The total capacitance of the three stage structure can be lower than a conventional two stage structure composed of a LVTSCR structure alone. A typical value is 0.85 pF, compared with 1.7 pF for a conventional two stage structure, as measured on a typical substrate at 3.3V, resulting in a reduction of around 50% in the capacitance when using the three stage structure of the invention.

In comparison with other structures, the solution presented herein is also more area efficient, largely due to the smaller size of the LVTSCR. Other solutions, such as gated diodes with large FETs (field effect transistors, also known as BigFETs), present typically the same capacitance but with a risk of over-voltage due to gated diodes having a relatively large breakdown voltage. STI (shallow trench isolation) diodes do not have this disadvantage, but at the penalty of a higher capacitance and a much larger occupied area. The solution presented herein therefore offers a more optimal match of capacitance with trigger voltage, allowing the size of the ESD protection circuit to be minimised.

The invention combines the advantages of each different ESD structure, without incurring the disadvantages of each. An LSCR has a large current capability and a low capacitance, but at the penalty of too high a triggering voltage. An LVTSCR, on the other hand, has a low triggering voltage but only a medium current capability for a low capacitance. By combining the two different SCRs in a cascade of stages, with the first stage handling the majority of the current, while the second stage provides the low triggering voltage, the combined ESD protection circuit is thereby more efficient.

Other embodiments are intentionally within the scope of the invention, as defined by the following claims.

1. An electrostatic discharge protection circuit for an integrated circuit, the electrostatic discharge protection circuit comprising:
a first silicon controlled rectifier structure having a first triggering voltage, the first rectifier structure being directly connected to an input of the circuit;
a second silicon controlled rectifier structure having a second triggering voltage lower than the first triggering voltage, the second rectifier being connected to the input via a resistor; and
a secondary over-voltage protection unit connected to the input via the resistor.

2. The electrostatic discharge protection circuit of claim 1 wherein the first silicon controlled rectifier is a lateral silicon controlled rectifier.

3. The electrostatic discharge protection circuit of claim 1 wherein the second silicon controlled rectifier is a low-voltage triggered silicon controlled rectifier.

4. The electrostatic discharge protection circuit of claim 1 wherein the resistor has a value of the order of 10² Ohms.

5. The electrostatic discharge protection circuit of claim 1 wherein the secondary over-voltage protection circuit comprises a grounded-gate NMOS transistor.

6. An integrated circuit chip comprising the electrostatic discharge protection circuit of claim 1 wherein the electrostatic discharge protection circuit is embedded inside a pad of the chip.
